(19) United States
(12) Patent Application Publication
(10) Pub. No.: US 2010/0018885 A1
(43) Pub. Date: Jan. 28, 2010

(54) Disposable lipstick

(76) Inventor: Mina Houtan, EHT, NJ (US)

Correspondence Address: Mina Houtan, Ph.D., 300 Central Avenue, Egg Harbor Township, NJ, 08234, US

(21) Appl. No.: 12/220,658

(22) Filed: Jul. 28, 2008

(51) Int. Cl. B65D 85/72; B43K 23/00; A45D 42/00; A45D 40/24; B43K 29/00

(52) U.S. Cl. 206/385; 401/98; 132/316; 132/318; 401/52

(57) ABSTRACT

A lipstick mechanism including an internal bed that springs up when opened and retracts when closed, containing a lipstick composition on individual applicators that are disposable after use. Lipstick is for aesthetic purposes and this improved invention is better because it prevents the spread of germs.

### BACKGROUND OF THE INVENTION

1. Field of the invention

The main purpose of this improved invention for lipstick, is for the prevention of contamination of the lipstick when a person is ill or has a mouth infection. This improved invention relates to a housing compartment for lipstick. More particularly, it relates to a retractable container that houses lipsticks, which contain pre-measured amounts of lip colorant on cotton-tipped applicators that fit into small cells within the housing container. The center of the container is hollowed to hold a wooden lip liner pencil that can be used with the lipstick.

2. Background Art

Make-up for the lips has played an essential role in the beauty for many centuries. Based on recent excavations, archaeological believe that Persians wore lipstick and make-up over 6000 years ago. Persian women spent time applying lipstick and make-up prior to seeing the King. Egyptians were known to use henna and plant dyes to paint their lips. The invention of the “lipstick” made application easy. But, while lipstick was convenient, it was soon discovered that they can sometimes break halfway down the stick, wasting money. It was considered that lipstick can also become contaminated with germs during use, when one was ill. It was also considered that lipstick transferred germs from one user to another when shared. While there are many varieties of lipstick products, in this lipstick product, the difference is the manner in which is it applied.

The main purpose of this improved invention for lipstick, is for the prevention of the spread of bacteria during sickness of the lipstick user or when shared. When women are ill, they still consider their overall appearance, therefore they continue to use their lipstick. When lipstick is applied to the lips in a normal manner, it is retracted and used over and over. Germs and bacteria are spread over the lips again and again with each use, preventing a sick person from improving from sickness, sooner. This improved invention provides a simple, single use, disposable lipstick that comes pre-measured on cotton-tipped applicators that are fitted into a lipstick housing compartment; containing 10 lip applicators. The applicators are disposable after each use and will eliminate cross contamination from mouth to lipstick repeatedly. This is especially essential in women that develop cold sores and other contagious sicknesses, but still need to keep their lips moist. Some women wipe off the top of the lipstick after each use; however this is wasteful and may not necessarily prevent the spread of germs. Normally, one would not share their lipstick, but with this improved invention, you can share your lipstick worry-free. This application is also very useful for the make-up artist to eliminate the spread of germs from one client to another.

### BRIEF SUMMARY OF THE INVENTION

Ordinary lipsticks are good breeding grounds for bacteria and viruses. This improved invention for lipstick is in the application itself. Because of the improved housing compartment for the lipstick, this product provides for germ free, worry free use of lipstick which is a great improvement. Make-up use in younger females is becoming more and more popular, however there are concerns regarding sharing of make-up even among friends. This improved product can be shared among many users and there will never be a concern of spreading germs and bacteria. This lipstick housing compartment employs the use of individual applicators that contain a pre-measured amount of lip colorant. The applicators are placed into a housing compartment containing multiple cells into which each shaft will fit. When the housing compartment is opened, it springs up allowing the user to grab one applicator at a time without disturbing the other ones. The inside lid of the compartment will be mirrored so you can use your lipstick anywhere. Once the lipstick is used, you simply throw it away. For variation, there will be a built-in lip liner pencil that can be used along with the lipstick. The inner chamber can be removed and replaced with a new inner chamber once all of the lipstick is used. Lip liners will also be available separately. Although this product can be used at any time, it's especially useful during periods of sickness including cold, cough, flu, cold sores, strep throat, or any germ spreading sickness. The same application system can be used for lipgloss, lip protectant, and others. The package will contain a pencil sharperner for the lip liner which should be used after each use to prevent lip infection.

### BRIEF DESCRIPTION OF THE DRAWINGS

FIG. 1

Shows the housing container, having a lid-which is attached by two hinges which stay secured by two notches on the front of the housing container on both sides parallel to the lid.

FIG. 1a

The lid to the housing container will have a mirror attached to the inside lid and will allow for the lid to be closed securely.

FIG. 1b

2 hinges will be required to attach the lid to the housing container.

FIG. 2

The inner housing unit which is attached to the cell compartment and is hollow in the center. This housing unit will hold a wooden lip liner pencil as well as the lipstick. This inner chamber will sit freely inside of the housing container and is completely removal and replaceable when the lipstick is used up, preventing waste to the environment.

FIG. 3

Shows the top portion of the lip liner pencil which is slightly bigger than the pencil itself. It acts as a cap and sits over the inner hollowed shaft without falling through.

FIG. 3a

The lip liner pencil itself can be made available in many color choices.

FIG. 4

The mirror of the housing container will fit securely to the inside lid.

FIG. 5

4 springs will be attached to the bottom of the housing container, allowing the unit housing unit to spring up above the top of the container when the lid is opened.

FIG. 6

This is the cell compartment which is connected to the inner housing unit and holds the lipstick applicators. This can be commercially available in a larger scale for the make-up artist.

FIG. 6a

Shows an enlarged portion of one of the cell compartments.

FIG. 7

An applicator which has a pre-moistened lipstick tip.

FIG. 7a

Shows the cotton tip that is about 3 mm in thickness.

### DETAILED DESCRIPTION OF THE INVENTION

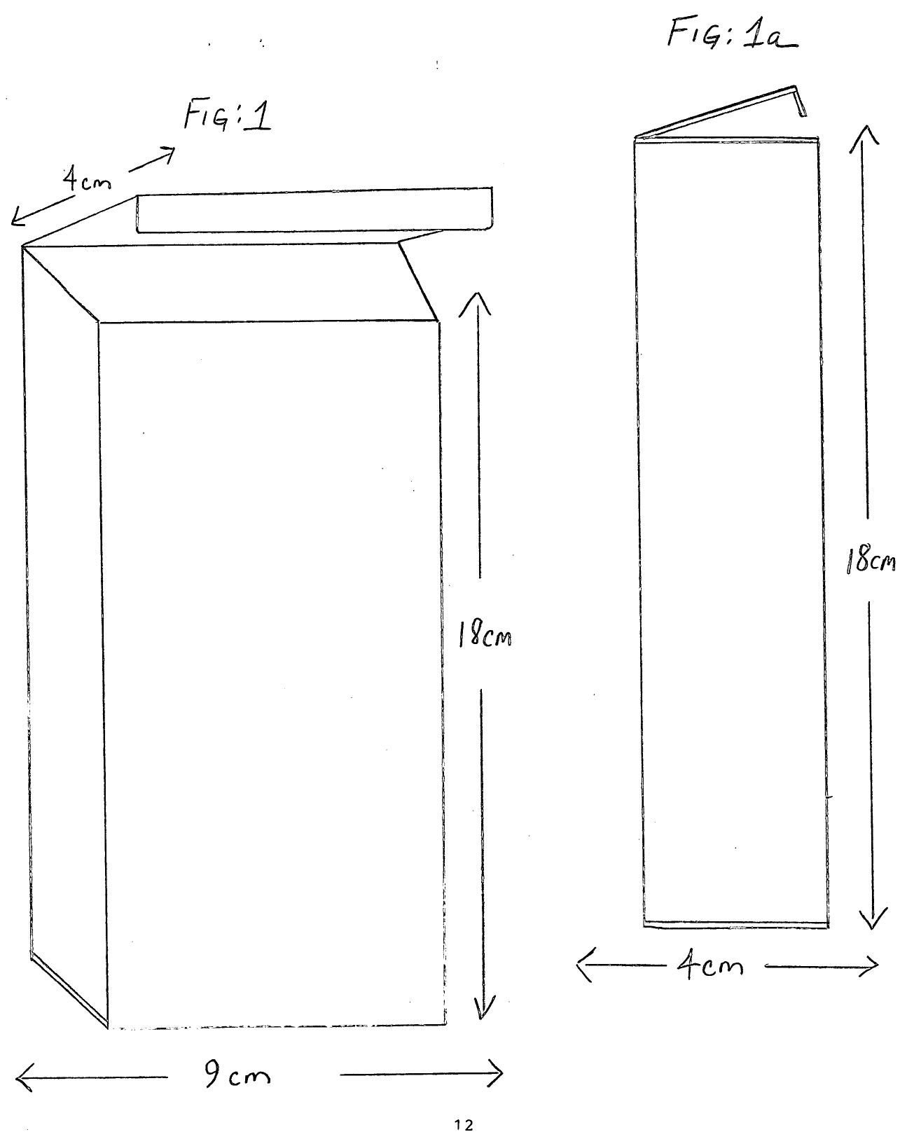

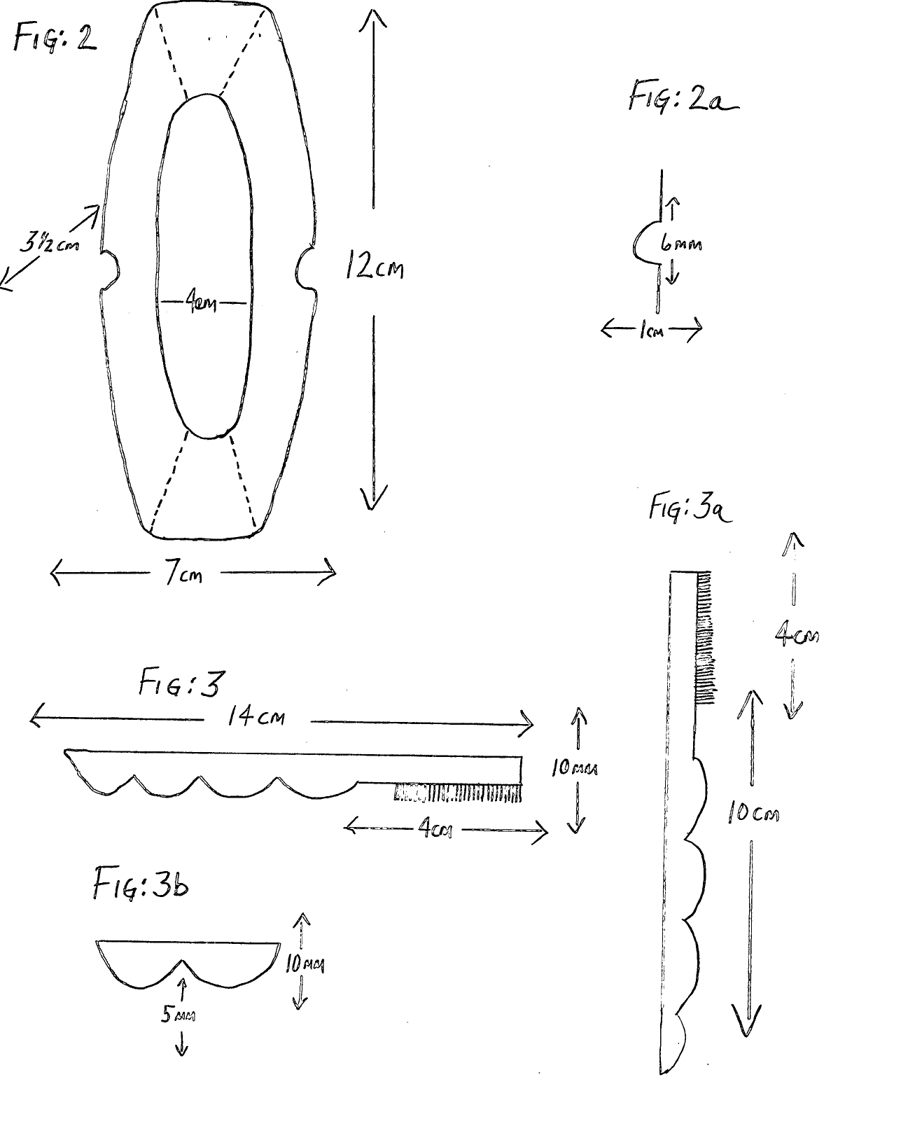

The process of this improved invention begins with the assembly of the main housing compartment (FIG. 1), which will require (2) 8 mm hinges (FIG. 1b) attached to the rear of the housing compartment and are opened and bent into the lid portion of the housing compartment (FIG. 1a). Inside of the main housing compartment is an inner housing unit (FIG. 2). This inner housing unit (FIG. 2) is connected to the cell container base (FIG. 6) and houses a lip liner pencil (FIG. 3). This inner housing unit (FIG. 2) is removal and can be replaced with a new inner housing unit (FIG. 2) once all of the lipstick is used up. The lipstick housing compartment (FIG. 1) is of pliable metals and is ⅛ mm in thickness as are the lid (FIG. 1a) and the hinges (FIG. 1b). The shaft (FIG. 7) is made of heavy, rolled paper similar to a lollipop stick.

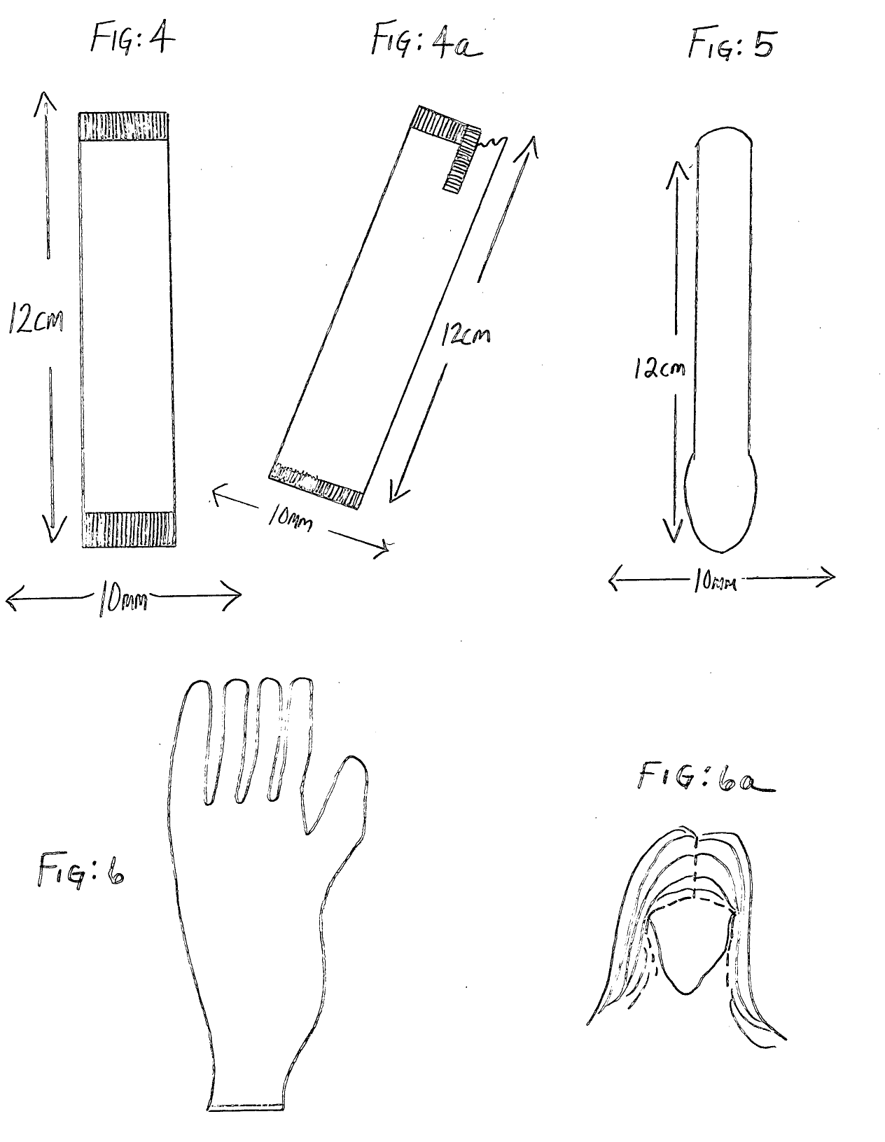

A mirror (FIG. 4) will be attached to the inside of the lid (FIG. 1a). The inner housing unit (FIG. 2) will sit freely inside of the main housing compartment (FIG. 1) on a set of 4 springs (FIG. 5) which will expand to 11 mm when the lid of the main housing compartment is opened. The cell compartments (FIG. 6) will hold the color coated lip stick applicators (FIG. 7) and are disposable after use.

The cotton tips (FIG. 7a) are made of a soft, smooth tightly woven cotton so that when applied to the mouth will not break apart and will contain a pre-dispensed amount of lip colorant, available in many colors. This colorant is added by having the cotton tipped applicators (FIG. 7) dipped into molten lipstick during the manufacturing process. After it cools, it's packaged into the housing unit (FIG. 1) fitting securely into the inner housing unit (FIG. 2) individual cell compartments (FIG. 6a).

The lipstick itself is a composition comprising by weight from 8-20% of wax, 30-80% of oils to 30% of colorants, 8-20% of cetearyl is ononanoate, 1-10% of sesquistearate and 2-20% of isopropyl hydroxy stearate. Even though this improved invention has been described in terms of the embodiment set forth in detail for purposes of explanation, it should be understood that the disclosed form is merely illustrative and in no way limits the color, size, shape, or configuration that can be used. The intention of this idea is preventing a sick person from contaminating herself by using the same contaminated lipstick over and over again, which means—we are introducing a new way to apply lipstick. The lipstick formula of any cosmetic company could be used with this improved invention.

1. This lipstick housing compartment can be made of pliable metals of various types. It has a removable inner housing unit.

2. The lipstick housing compartment of claim 1 will house multiple lipstick applicators that are disposable after use.

3. The lipstick housing compartment of claim 1 will house a separate lip liner pencil in the center of the inner housing compartment.

4. The inner housing unit of claims 1 through 3 will have individual cell compartments.

5. The lipstick applicators of claim 2 will be available in multiple colors and are disposable after use. The disposable applicators prevent the cross contamination of the lipstick from the mouth especially during the users sickness.

6. The lipstick applicators of claims 2 and 6 will fit into the cell compartments of claim 4.

7. The lipstick inner housing unit will spring up when the lid of the lipstick housing compartment is opened and then it will retract when the lid is closed.

8. The lipstick housing compartment will have a mirror attached to the inner part of the lid.
